(19) United States
(12) Patent Application Publication
(10) Pub. No.: US 2014/0360746 A1
(43) Pub. Date: Dec. 11, 2014

(54) Electric Tool

(71) Applicant: Robert Bosch GmbH, Stuttgart (DE)

(72) Inventor: Jan Hiller, Nuertingen (DE)

(73) Assignee: Robert Bosch GmbH, Stuttgart (DE)

(21) Appl. No.: 14/268,100

(22) Filed: May 2, 2014

(30) Foreign Application Priority Data
Jun. 5, 2013 (DE) 10 2013 210 391.3

(51) Int. Cl. B23B 45/02; B23B 45/00

(52) U.S. Cl. CPC B23B 45/02; B23B 45/001; B23B 2270/022
USPC 173/217

(57) ABSTRACT

An electric tool includes a housing unit which has a grip unit that is angled with respect to a longitudinal direction of the housing unit. The electric tool also includes a drive unit which has a tool receptacle that is drivable about a tool axis by the drive unit, and a pivoting unit which is configured to mount the tool receptacle in a pivotable manner about at least one pivot axis relative to the drive unit. A drive axis of the drive unit is located so as to be at least substantially parallel to a main extent of the grip unit.

This application claims priority under 35 U.S.C. §119 to patent application no. DE 10 2013 210 391.3, filed on Jun. 5, 2013 in Germany, the disclosure of which is incorporated herein by reference in its entirety.

### BACKGROUND

An electric tool having a housing unit which has a grip unit that is angled with respect to a longitudinal direction of the housing unit, having a drive unit, having a tool receptacle that is drivable about a tool axis by the drive unit, and having a pivoting unit which is provided so as to mount the tool receptacle in a pivotable manner about at least one pivot axis relative to the drive unit, has already been proposed.

### SUMMARY

The disclosure proceeds from an electric tool, in particular a drill driver, having a housing unit which has a grip unit that is angled with respect to a longitudinal direction of the housing unit, having a drive unit, having a tool receptacle that is drivable about a tool axis by the drive unit, and having a pivoting unit which is provided so as to mount the tool receptacle in a pivotable manner about at least one pivot axis relative to the drive unit.

It is proposed that a drive axis of the drive unit is arranged so as to be at least substantially parallel to a main extent of the grip unit. In this connection, an “electric tool” should be understood to mean in particular an electrically driven, preferably handheld, power tool. Preferably, the electric tool is rechargeable-battery operated and has a portable power tool rechargeable battery. A “drill driver” should in this connection be understood to mean in particular a portable power tool which is provided for drilling and/or screwing operations. Preferably, the drill driver has a torque limiting means, for example a friction clutch. Preferably, the drill driver can be operated with clockwise and/or counterclockwise rotation. A “housing unit” should in this connection be understood to mean in particular a protective housing that delimits the electric tool towards the outside. Preferably, the housing unit is formed at least partially from a plastics material. Preferably, the housing unit is formed in a plurality of parts. A “grip unit” should in this connection be understood to mean in particular a unit which is provided to be gripped by a user with at least parts of one hand in order to guide the electric tool. A “longitudinal direction” of the housing unit should in this connection be understood to mean in particular a direction which is at least substantially parallel to a main extent of the housing unit.

Preferably, the longitudinal direction is at least substantially parallel to the tool axis in a neutral position of the pivoting unit. The expression “at least substantially” should in this connection be understood to mean in particular a deviation of less than 45°, preferably less than 30°, particularly preferably less than 15°. An “angled” grip unit should in this connection be understood to mean in particular that a main extent of the grip unit forms an angle of between 30° and 90°, preferably between 45° and 90°, particularly preferably between 60° and 90°, with the longitudinal direction of the housing unit. In particular, the housing unit having the grip unit can have what is known as a pistol shape. A “drive unit” should in this connection be understood to mean in particular a unit which is provided so as to produce a rotary drive movement. The drive unit preferably has an electric motor. Preferably, the drive unit can have a transmission unit which is provided to step down a rotary movement of the electric motor to the rotary drive movement. A “tool receptacle” should in this connection be understood to mean in particular a drill chuck and/or bit holder, wherein the tool receptacle is provided to receive a drilling and/or screwing tool that is exchangeable by a user. A “tool axis” should in this connection be understood to mean an axis about which the tool receptacle moves a tool in rotation with a working movement in order to machine a workpiece or to screw in and/or unscrew a screw. A “pivoting unit” should in this connection be understood to mean in particular a device which is provided to mount the tool receptacle in a pivotable manner and in the process to transmit the drive movement from the drive unit to the tool receptacle. A “pivot axis” should in this connection be understood to mean in particular a rotational degree of freedom by which the pivoting unit allows the tool receptacle to pivot. The pivot axis deviates in particular from the tool axis of the tool receptacle. Preferably, the pivoting unit has fixing means which are provided to fix the tool receptacle in a desired pivoted position. The fixing means can fix the pivoted position in a form- and/or force-fitting manner. The pivoted position can be fixable in steps or preferably in a stepless manner. Preferably, a clamping device for fixing the pivoted position in a force-fitting manner can be provided. Preferably, the pivoting unit has a neutral position which is particularly suitable for drilling and/or screwing operations in which a pivoted tool is not required. The neutral position can be distinguished by the fact that the tool axis and longitudinal axis of the housing unit are aligned. The electric tool can have particularly high symmetry with the tool receptacle in the neutral position; a flow of force from the grip unit to the tool receptacle during a work operation can be particularly favorable and in particular have particularly low torques. The “drive axis of the drive unit” should in this connection be understood to mean in particular the drive axis of the motor of the drive unit. As a result of the drive axis of the drive unit being arranged at least substantially parallel to the main extent of the grip unit, the electric tool can be formed in a particularly ergonomic manner for the user. The expression “at least substantially” should in this connection be understood to mean in particular a deviation of less than 45°, preferably less than 30° , particularly preferably less than 15°. In particular, the drive unit, starting from the tool axis, and the grip unit can point in a common direction. A center of gravity of the electric tool can be located, as seen from the tool axis, on the side of the grip unit. The electric tool can be held particularly comfortably by the user.

It is furthermore proposed that the electric tool has a further grip unit which is spaced apart from the first grip unit at least substantially in a direction perpendicular to the drive axis of the drive unit. The second grip unit is advantageously spaced apart at least substantially perpendicularly to the main extent of the first grip unit, in particular in the longitudinal direction of the housing unit. The expression “at least substantially” should in this connection be understood to mean in particular a deviation of less than 30°, preferably less than 15°, particularly preferably less than 5°. The electric tool can be held particularly comfortably with the two grip units. In particular, it is possible for torques that arise by way of the tool that is angled with respect to the longitudinal direction of the housing unit to be absorbed particularly well by the user, when working with a pivoted pivoting unit, with the two spaced-apart grips.

It is furthermore proposed that the drive unit is arranged at least partially in the further grip unit. Preferably, the further grip unit surrounds the drive unit. The space available in the further grip unit can advantageously be used. The center of gravity of the drive unit can be located within the further grip unit. The electric tool can be held particularly comfortably. An inclination for the electric tool to tip about a center of gravity located high above the grip units can be reduced. Utilization of the space in the housing unit can be particularly high.

It is furthermore proposed that the first grip unit has a receptacle region for a portable power tool rechargeable battery. The space available in the first grip unit can advantageously be used. A weight of the portable power tool rechargeable battery can advantageously balance out a weight of the drive unit in the further grip unit. A center of gravity of the electric tool with inserted portable power tool rechargeable battery can be arranged advantageously between the two grip units. The electric tool can be held particularly comfortably.

It is furthermore proposed that the pivoting unit has at least one angular transmission. A drive movement can advantageously be diverted from the drive axis of the drive unit in the direction of the tool axis that is pivotable by way of the pivoting unit. Preferably, the pivoting unit has a bevel gear transmission. The bevel gear transmission can have a particularly compact structure. A transmissible torque can be particularly high.

It is furthermore proposed that the pivot axis of the pivoting unit is arranged at least substantially parallel to the drive axis of the drive unit. The expression “at least substantially” should in this connection be understood to mean in particular a deviation of less than 30°, preferably less than 15°, particularly preferably less than 5°. The tool receptacle can advantageously be pivoted about the pivot axis transversely to a plane formed by the longitudinal direction of the housing unit and the main extents of the grip units.

Particularly advantageously, the pivot axis of the pivoting unit is arranged in an at least substantially axial manner with respect to the drive axis of the drive unit. The expression “at least substantially” should in this connection be understood to mean in particular a deviation of less than 30°, preferably less than 15°, particularly preferably less than 5°. It can be particularly easy to couple the drive axis of the drive unit to the pivoting unit, in particular by way of a bevel gear, the drive axis of which intersects the pivot axis.

It is furthermore proposed that the pivoting unit has a further pivot axis which is arranged at least substantially in a direction perpendicular to the drive axis of the drive unit and to the tool axis of the tool receptacle. The pivot axes can be mechanically configured movement axes of the pivoting unit. Alternatively, the pivot axes can represent two rotational degrees of freedom, deviating from the tool axis of the tool receptacle, of the pivoting unit, which are formed by the pivoting transmission by way of deviating measures. In particular, the pivoting transmission can have a ball joint which allows any desired rotational movements in two degrees of freedom. The tool receptacle can advantageously be pivotable in two degrees of freedom. The user can work particularly flexibly with the electric tool.

Advantageously, the drive axis of the drive unit encloses a largest angle of more than 90° and less than 140°, particularly advantageously more than 90° and less than 120°, with the longitudinal direction of the housing unit. An at least substantially parallel orientation of the grip units can be particularly ergonomic.

Furthermore, a pivot drive module for an electric tool having the properties according to the disclosure, having a pivoting unit and having a drive unit for an electric tool, is proposed. The pivot drive module can in particular include the motor and/or the transmission and/or the pivoting unit and/or a spindle for receiving the tool receptacle and/or the tool receptacle and/or fixing means for the pivoting unit. The pivot drive module can advantageously be preassembled. The pivot drive module can be integrated particularly easily into an electric tool. An electric tool having the pivot drive module can be particularly cost-effective.

The electric tool according to the disclosure is not intended to be limited here to the above-described application and embodiment. In particular, the electric tool according to the disclosure can have a number of individual elements, components and units that differs from a number mentioned herein in order to fulfill a mode of operation described herein.

### BRIEF DESCRIPTION OF THE DRAWINGS

Further advantages can be gathered from the following description of the drawings. The drawings illustrate three exemplary embodiments of the disclosure. The drawings, the description and the claims contain numerous features in combination. A person skilled in the art will expediently also consider the features individually and combine them to form appropriate further combinations.

In the drawings:

FIG. 1 shows a schematic illustration of an electric tool according to the disclosure having a pivoting unit and also a first and a further grip unit,

FIG. 2 shows a schematic illustration of the pivoting unit, a drive unit and the first and the further grip unit,

FIG. 3 shows a schematic illustration of a pivoting unit, a drive unit and also a first and a further grip unit of an electric tool in a second exemplary embodiment, and

FIG. 4 shows a schematic illustration of a pivoting unit, a drive unit and a first and a further grip unit of an electric tool in a third exemplary embodiment.

### DETAILED DESCRIPTION

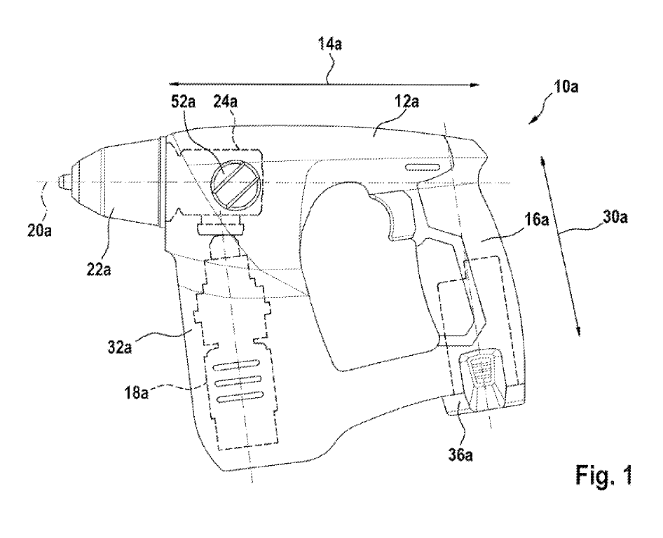

FIG. 1 shows an electric tool 10a, embodied as a drill driver, having a housing unit 12a which has a first grip unit 16a, which is angled with respect to a longitudinal direction 14a of the housing unit 12a and is in the form of a main handle, having a drive unit 18a, having a tool receptacle 22a which is drivable about a tool axis 20a by the drive unit 18a, and having a pivoting unit 24a which is provided to mount the tool receptacle 22a in a pivotable manner about a pivot axis 26a relative to the drive unit 18a. The electric tool 10a is intended for drilling and screwing operations. For this purpose, drilling and screwing tools such as drill bits and screw bits can be clamped in the tool receptacle 22a. In a neutral position 46a, the tool axis 20a is oriented in the direction of a main extent 30a of the housing unit 12a. A tool switch 48a is arranged on the first grip unit 16a. By pressing the tool switch 48a in the longitudinal direction 14a, the electric tool 10a is set into operation, so that the tool receptacle 22a starts to rotate in a working movement about the tool axis 20a.

The drive unit 18a is arranged in a further grip unit 32a which is formed by a part of the housing unit 12a that faces the tool receptacle 22a. The drive unit 18a has a motor 50a having a drive axis 28a. The drive unit 18a is arranged with its drive axis 28a substantially parallel to a main extent 30a of the first grip unit 16a. The first grip unit 16a also has a receptacle region 34a for a portable power tool rechargeable battery 36a. The further grip unit 32a is arranged in a manner spaced apart from the first grip unit 16a substantially in a direction perpendicular to the drive axis 28a of a drive unit 18a. The spacing is selected such that a user can grasp the first grip unit 16a, in the form of the main handle and having the tool switch 48a, with one hand, and can grasp the further grip unit 32a with the other hand. On account of the spacing, the user can comfortably absorb in particular torques that act on the electric tool 10a.

The pivoting unit 24a has an angular transmission 38a (illustrated only schematically here), which is in the form of a bevel gear transmission. The user can fix a desired pivoted position via a clamping device 52a. The pivoting unit 24a mounts the tool receptacle 22a in a pivotable manner about the pivot axis 26a which is arranged perpendicularly to the tool axis 20a and in a plane of symmetry 54a of the housing unit 12a. The drive axis 28a of the drive unit 18a is arranged in a manner inclined at an angle of less than 20° with respect to the pivot axis 26a of the pivoting unit 24a. The drive axis 28a of the drive unit 18a thus encloses a largest angle 42a of 110° with the longitudinal direction 14a of the housing unit 12a. The grip units 16a and 32a likewise have a corresponding inclination with respect to the pivot axis 26a. The electric tool 10a can thus be guided in a particularly ergonomic manner with slightly angled wrists. A spur gear transmission 56a is used to transmit a drive moment from the drive axis 28a to the angular transmission 38a and evens out the inclination of the drive axis 28a with respect to the pivot axis 26a.

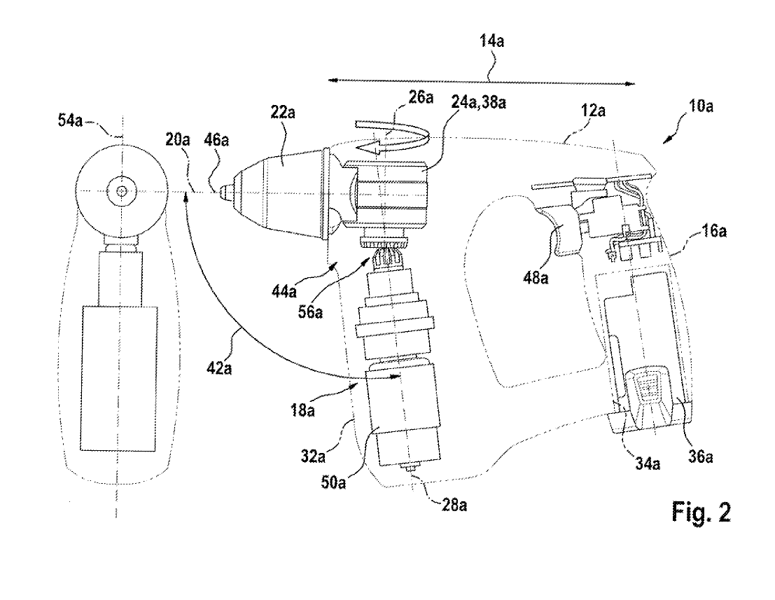

The pivoting unit 24a and the drive unit 18a form a pivot drive module 44a (illustrated in FIG. 2) for the electric tool 10a, said pivot drive module 44a being preassembled and installed in the electric tool 10a.

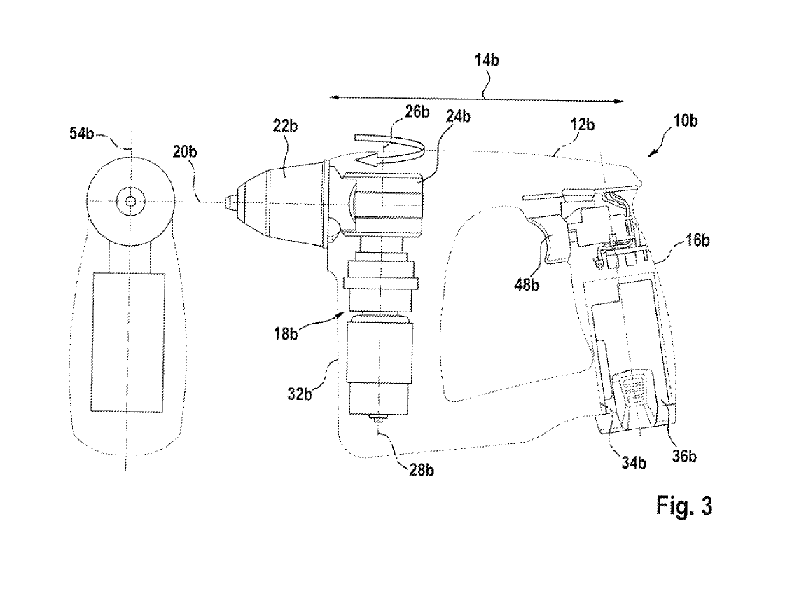

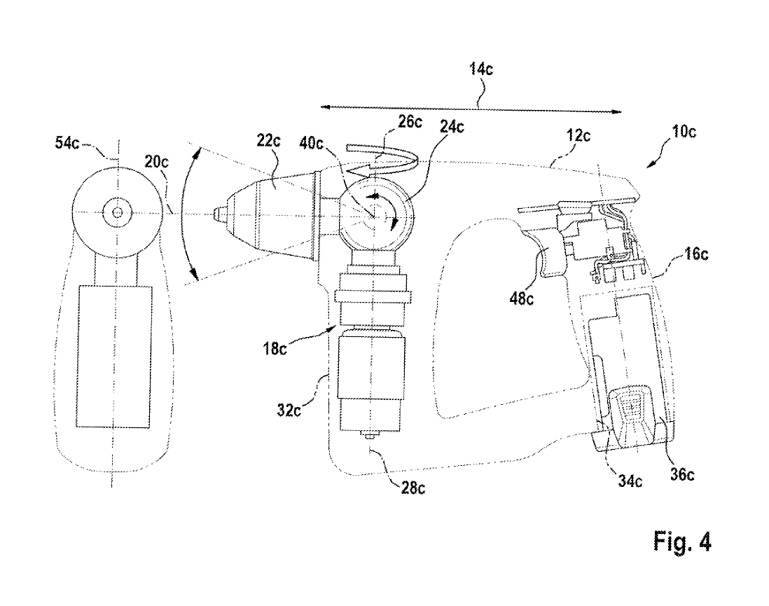

FIGS. 3 and 4 show two further exemplary embodiments of the disclosure. The following descriptions and the drawing are limited essentially to the differences between the exemplary embodiments, it being possible to refer in principle also to the drawing and/or the description of the other exemplary embodiments, in particular FIGS. 1 and 2, with regard to identically designated components, in particular with regard to components having the same reference signs. In order to distinguish between the exemplary embodiments, the letter a is placed after the reference signs of the exemplary embodiment in FIGS. 1 and 2. In the exemplary embodiments in FIGS. 3 and 4, the letter a is replaced by the letters b and c.

FIG. 3 shows a pivoting unit 24b, a drive unit 18b and a first and a further grip unit 16b, 32b of an electric tool 10b in a second exemplary embodiment. The electric tool 10b differs from the electric tool 10a in the first exemplary embodiment in particular in that a pivot axis 26b of the pivoting unit 24b is arranged parallel to and axially with respect to a drive axis 28b of the drive unit 18b. The further grip unit 32b, in which the drive unit 18b is arranged, is arranged more steeply with respect to a longitudinal direction 14b of a housing unit 12b than the first grip unit 16b, configured as the main handle, which has a receptacle region 34b for a portable power tool rechargeable battery 36b. The housing unit 12b is built in a particularly slim manner in the region of the further grip unit 32b on account of the steeply arranged drive unit 18b.

FIG. 4 shows a pivoting unit 24c, a drive unit 18c and a first and a further grip unit 16c, 32c of an electric tool 10c in a third exemplary embodiment. The electric tool 10c differs from the electric tool 10b in the second exemplary embodiment in particular in that the pivoting unit 24c is in the form of a ball-joint transmission and has a further pivot axis 40c which is arranged perpendicularly to a drive axis 28c of a drive unit 18c and to a tool axis 20c of a tool receptacle 22c. The tool receptacle 22c can advantageously be pivoted about a first pivot axis 26c to the left and to the right with respect to a plane of symmetry 54c of a housing unit 12c and about the second pivot axis 40c, arranged perpendicularly to the plane of symmetry 54c, in and counter to the direction of the grip units 16c, 32c. The electric tool 10c can thus be used in a particularly flexible manner.

What is claimed is:

1. An electric tool, comprising:
a housing unit that includes a grip unit that is angled with respect to a longitudinal direction of the housing unit;
a drive unit that includes a tool receptacle:
wherein the drive unit is configured to drive the tool receptacle about a tool axis; and
wherein a drive axis of the drive unit is located so as to be at least substantially parallel to a main extent of the grip unit; and
a pivoting unit, wherein the tool receptacle is mounted in the pivoting unit in a pivotable manner about at least one pivot axis relative to the drive unit.

2. The electric tool according to claim 1, further comprising a further grip unit which is spaced apart from the grip unit at least substantially in a direction perpendicular to the drive axis.

3. The electric tool according to claim 2, wherein the drive unit is positioned at least partially in the further grip unit.

4. The electric tool according to claim 1, wherein the grip unit has a receptacle region configured to receive a portable power tool rechargeable battery.

5. The electric tool according to claim 1, wherein the pivoting unit has at least one angular transmission.

6. The electric tool according to claim 1, wherein the at least one pivot axis is located at least substantially parallel to the drive axis.

7. The electric tool according to claim 1, wherein the at least one pivot axis is located in an at least substantially axial manner with respect to the drive axis.

8. The electric tool according to claim 1, wherein the pivoting unit is further configured to mount the tool receptacle in a pivotable manner about a further pivot axis relative to the drive unit which is located at least substantially in a direction perpendicular to the drive axis and to the tool axis.

9. The electric tool according to claim 1, wherein the drive axis encloses a largest angle of more than 90 degrees and less than 140 degrees with the longitudinal direction of the housing unit.

10. A pivot drive module for an electric tool that has a housing unit with a grip unit at an angle with respect to a longitudinal direction of the housing unit, the pivot drive module comprising:
a drive unit that includes a tool receptacle, wherein the drive unit is configured to drive the tool receptacle about a tool axis, and is further configured such that a drive axis of the drive unit is located so as to be at least substantially parallel to a main extent of the grip unit of the electric tool; and
a pivot unit, wherein the tool receptacle is mounted in the pivoting unit in a pivotable manner about at least one pivot axis relative to the drive unit.
